(19) United States
(12) Patent Application Publication
(10) Pub. No.: US 2026/0316065 A1
(43) Pub. Date: Oct. 15, 2026

(54) LATENT BASE CATALYST AND COATING COMPOSITION INCLUDING THE SAME

(71) Applicant: SWIMC LLC, Cleveland, OH (US)

(72) Inventors: Ruisong XU, Solon, OH (US); Seyedali BANISADR, Cleveland Heights, OH (US)

(21) Appl. No.: 19/484,457

(22) PCT Filed: May 15, 2024
(86) PCT No.: PCT/US2024/029378

§ 371 Date: Nov. 14, 2025

Related U.S. Application Data
(60) Provisional application No. 63/502,673, filed on May 17, 2023.

(51) Int. Cl. B01J 31/02; C09D 7/63

(52) U.S. Cl. CPC B01J 31/0265; C09D 7/63; B01J 2231/42

(57) ABSTRACT

The present disclosure provides a latent base catalyst for use in two-component crosslinkable coating systems, and preferably a strong latent base catalyst including carbonate, bicarbonate, and/or carbamate salts suitable for use in two-component Michael addition chemistry. The latent base catalyst is a salt having a structure of BH⁺ A⁻ where the BH⁺ moiety thereof is a cation of a strong base or the conjugated acid of a strong base and includes one of a linear or cyclic amidine moiety or cation, a linear or cyclic guanidine moiety or cation, or a phosphazene moiety or cation. The A⁻ moiety thereof is a carbonate anion, a bicarbonate anion, or a carbamate anion.

### CROSS REFERENCE TO RELATED APPLICATION

This application claims priority to and the benefit of U.S. provisional application No. 63/502,673 filed on May 17, 2023, the entirety of which is hereby incorporated by reference.

### TECHNICAL FIELD

This disclosure relates to latent catalysts and to coating compositions including such latent catalysts, and in particular, latent base catalysts for use in two-component crosslinkable coating systems.

### BACKGROUND

Typically, crosslinkable two-component compositions are coating compositions where the components are stored separately and mixed prior to use. The two components are often highly reactive and will begin to crosslink as soon as they are mixed. It is conventional to include a catalyst in such coating systems to increase the rate of the crosslinking reaction between the two components.

The crosslinking reaction may be base-catalyzed or acid-catalyzed. Base-catalyzed systems are sometimes preferred because they are capable of fast cure. However, because of the rapid rate of cure, prior base-catalyzed compositions can only be used for a relatively short period of time after the components are mixed, defined as the pot-life of the coating composition. In some base-catalyzed systems, viscosity increases so rapidly that the coating starts to cure before it can be fully applied to a surface, and accordingly, these systems are of limited practical use.

For waterborne systems where viscosity may not be a good indicator for pot-life, the hardness and/or the gloss level of applied coating at various times may be used a measure of pot life. Due to concerns regarding the use of volatile organic compounds (VOC) in coatings, high solids systems with low solvent content or even waterborne systems substantially free of solvent are oftentimes preferred. However, such systems present several additional challenges with regard to balancing pot-life, hardness/gloss and kinetics of cure or dry speed. For example, a high solids composition typically includes less solvent that can evaporate when the coating is applied, and as a result, the pot-life is much lower than preferred.

On the other hand, the increase in reaction rate when the coating is applied is also reduced with less solvent in the system, leading to slower cure. Thus, a combination of rapid cure and long pot-life is often challenging to achieve for two-component, high-solids solvent borne coating systems and/or for waterborne systems where the reaction may occur in the dispersion phase. Thus, a further challenge in two-component crosslinkable systems, both solvent borne and waterborne, using latent catalysts is the cure kinetics at room temperature or so-called low bake conditions of about 100° C. or less. Prior systems using latent base catalysts oftentimes required too high of an activation temperature for such systems to have cure kinetics practicable at the lower room temperature or low bake conditions. In some prior systems, the latent base catalyst may be blocked to provide desired pot life. However, blocked catalysts also provide challenges. For instance, blocked catalysts tend to deposit or leave salts in a dried coating film that, in some circumstances, may degrade coating performance. In other instances, only the anionic portion of a blocked catalyst after the de-blocking acts as a base for catalyzing the reaction.

### SUMMARY

The present application describes a latent base catalyst that addresses the shortcomings set forth in the Background above. In one approach or embodiment, the present application describes a latent base catalyst for use in two-component crosslinkable coating systems that, among other features, is suitable for waterborne and/or solvent borne Michael addition coating systems and, in particular, latent base catalysts that can offer long pot-life and/or fast cure kinetics for the waterborne and/or solvent borne Michael addition coating systems at ambient and/or low-bake conditions as discussed further herein. For instance, the latent base catalyst may include a salt having a structure of BH⁺ A⁻ (Formula I); wherein BH⁺ is a conjugated acid of a strong base and includes a linear or cyclic amidine moiety, a linear or cyclic guanidine moiety, or a phosphazene moiety; and wherein A⁻ is a carbonate anion, a bicarbonate anion, or a carbamate anion.

In other approaches or embodiments, the latent base catalyst of the previous paragraph may be combined with optional features or embodiments in any combination. The optional features or embodiments may include one or more of the following: wherein BH⁺ of Formula I includes the amidine moiety and has the structure of Formula II

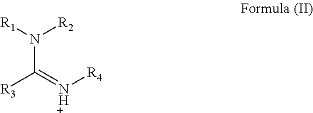

wherein R₁, R₂, R₃, and R₄ are each, independently, hydrogen or a substituted or unsubstituted alkyl group; and/or wherein each of R₂ and R₄ are the substituted or unsubstituted alkyl group and R₂ and R₄, along with the atoms to which they are attached, combine to form a substituted or unsubstituted first ring structure; and/or wherein R₂ and R₄ combined provide 2 to 18 carbons in the first ring structure; and/or wherein each of R₁ and R₃ are the substituted or unsubstituted alkyl group and R₁ and R₃, along with the atoms to which they are attached, combine to form a substituted or unsubstituted second ring structure; and/or wherein R₁ and R₃ combined provide 3 to 19 carbons in the second ring structure; and/or wherein BH⁺ of Formula I includes the guanidine moiety and has the structure of Formula III

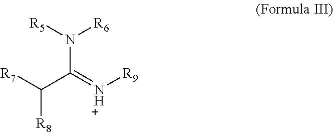

wherein R₅, R₆, R₇, R₈ and R₉ are each, independently, hydrogen or a substituted or unsubstituted alkyl group; and/or wherein each of R₅ and R₇ are the substituted or unsubstituted alkyl group and R₅ and R₇, along with the atoms to which they are attached, combine to form a substituted or unsubstituted first ring structure and each of R₆ and R₉ are the substituted or unsubstituted alkyl group and R₆ and R₉, along with the atoms to which they are attached, combine to form a substituted or unsubstituted second ring structure; and/or wherein of R₅ and R₇ combined provide 3 to 18 carbons in the first ring structure and R₆ and R₉ combined provide 3 to 18 carbons in the second ring structure; and/or wherein BH⁺ of Formula I includes the phosphazene moiety and has the structure of Formula IV

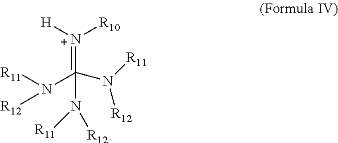

wherein R₁₀, R₁₁, and R₁₂ are each, independently, hydrogen or a substituted or unsubstituted alkyl group and, optionally, adjacent R₁₁ and R₁₂ groups, along with the atoms to which they are attached, may combine to form a substituted or unsubstituted ring structure; and/or wherein A⁻ has the structure of Formula V

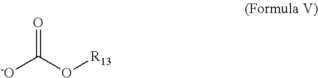

wherein R₁₃ is hydrogen, alkyl, aryl, alkaryl, hydrocarbyl, or combinations thereof; and/or wherein R₁₃ is a hydrocarbyl group and wherein, optionally, one or more carbon atoms thereof is replaced with a moiety selected from —O—, —S—, —C(O)—, —C(O)O—, —OC(O)O—, —S(O)—, —SO2-, —N(Rₓ)—, —Si(—Rₓ)(R_{y})—, or combinations thereof, wherein Rₓ and R_{y} are each independently selected from hydrogen, a hydrocarbyl group, or a substituted hydrocarbyl group; and/or wherein A has the structure of Formula VI

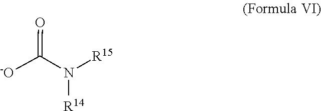

wherein R₁₄ and R₁₅ are each, independently, hydrogen or linear or branched alkyl, aryl, alkaryl, hydrocarbyl, or combinations thereof; and/or wherein one or both of R₁₃ and R₁₄ is, independently, a hydrocarbyl group and wherein, optionally, one or more carbon atoms thereof is replaced with a moiety selected from —O—, —S—, —C(O)—, —C(O)O—, —OC(O)O—, —S(O)—, —SO2-, —N(Rₓ)—, —Si(—Rₓ)(R_{y})—, or combinations thereof, wherein Rₓ and R_{y} are each independently selected from hydrogen, a hydrocarbyl group, or a substituted hydrocarbyl group; and/or wherein R₁₄ and R₁₅ including the nitrogen atom to which they are attached combine to form a ring structure; and/or wherein the ring structure is a heterocyclic ring structure; and/or wherein the heterocyclic ring structure is a succinimide ring structure; and/or wherein the pKa in water of the conjugated acid of the base in the latent base catalyst is at least about 10.

In other embodiment or approaches of the present application, a crosslinkable two-component waterborne or solvent borne coating composition is described herein. The composition may include a water-based or an organic solvent-based carrier fluid; a first ingredient or portion thereof having at least two protons that can be activated to form a Michael carbanion donor; a second ingredient or portion thereof having at least two ethylenically unsaturated functionalities each activated by an electron-withdrawing group to form a Michael acceptor; and any embodiment of the latent base catalyst described in this Summary.

The crosslinkable two-component waterborne or solvent borne coating composition of the previous paragraph may be combined with one or more optional features or embodiments in any combination. The optional features or embodiments may include one or more of the following: wherein the coating composition further includes pigments, matting agents, fillers, wetting agents, defoamers, rheological modifiers, ultraviolet (UV) light stabilizers, dispersing agents, flow and leveling agents, optical brighteners, gloss additives, radical inhibitors, radical initiators, adhesion promotors, plasticizers, waxes, or combinations thereof; and/or wherein the composition includes about 0.01 to about 20 weight percent of the latent base catalyst; and/or wherein the composition includes a weight ratio of the Michael carbanion donor to the Michael acceptor of about 1:3 to about 3:1, preferably about 1:2 to about 2:1, and more preferably about 1:1.5 to about 1.5:1; and/or wherein the carrier fluid includes about 5 to 100 weight percent water based on the total weight of the carrier fluid.

### Selected Definitions

Unless otherwise specified, the following terms as used herein have the meanings provided below.

As used herein, the term “organic group” means a hydrocarbon group (with optional elements other than carbon and hydrogen, such as oxygen, nitrogen, sulfur, and silicon) that is classified as an aliphatic group, cyclic group, or combination of aliphatic and cyclic groups (e.g., alkaryl and aralkyl groups). The term “aliphatic group” means a saturated or unsaturated linear or branched hydrocarbon group. This term is used to encompass alkyl, alkenyl, and alkynyl groups, for example. The term “alkyl group” means a saturated linear or branched hydrocarbon group including, for example, methyl, ethyl, isopropyl, t-butyl, heptyl, dodecyl, octadecyl, amyl, 2-ethylhexyl, and the like. The term “alkenyl group” means an unsaturated, linear or branched hydrocarbon group with one or more carbon-carbon double bonds, such as a vinyl group. The term “alkynyl group” means an unsaturated, linear or branched hydrocarbon group with one or more carbon-carbon triple bonds. The term “cyclic group” means a closed ring hydrocarbon group that is classified as an alicyclic group or an aromatic group, both of which can include heteroatoms. The term “alicyclic group” means a cyclic hydrocarbon group having properties resembling those of aliphatic groups. The term “Ar” refers to a divalent aryl group (i.e., an arylene group), which refers to a closed aromatic ring or ring system such as phenylene, naphthylene, biphenylene, fluorenylene, and indenyl, as well as heteroarylene groups (i.e., a closed ring hydrocarbon in which one or more of the atoms in the ring is an element other than carbon (e.g., nitrogen, oxygen, sulfur, etc.)). Suitable heteroaryl groups include furyl, thienyl, pyridyl, quinolinyl, isoquinolinyl, indolyl, isoindolyl, triazolyl, pyrrolyl, tetrazolyl, imidazolyl, pyrazolyl, oxazolyl, thiazolyl, benzofuranyl, benzothiophenyl, carbazolyl, benzoxazolyl, pyrimidinyl, benzimidazolyl, quinoxalinyl, benzothiazolyl, naphthyridinyl, isoxazolyl, isothiazolyl, purinyl, quinazolinyl, pyrazinyl, 1-oxidopyridyl, pyridazinyl, triazinyl, tetrazinyl, oxadiazolyl, thiadiazolyl, and so on. When such groups are divalent, they are typically referred to as “heteroarylene” groups (e.g., furylene, pyridylene, etc.)

A group that may be the same or different is referred to as being “independently” something. Substitution is anticipated on the organic groups of the compounds of the present invention. As a means of simplifying the discussion and recitation of certain terminology used throughout this application, the terms “group” and “moiety” are used to differentiate between chemical species that allow for substitution or that may be substituted and those that do not allow or may not be so substituted. Thus, when the term “group” is used to describe a chemical substituent, the described chemical material includes the unsubstituted group and that group with O, N, Si, or S atoms, for example, in the chain (as in an alkoxy group) as well as carbonyl groups or other conventional substitution. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, t-butyl, and the like.

The term “component” refers to any compound that includes a particular feature or structure. Examples of components include compounds, monomers, oligomers, polymers, and organic groups contained there.

The term “double bond” is non-limiting and refers to any type of double bond between any suitable atoms (e.g., C, O, N, etc.).

The term “triple bond” is non-limiting and refers to any type of triple bond between any suitable atoms.

“Catalyst” as used herein is a latent base catalyst in the form of a salt having a structure of BH⁺A⁻ wherein BH⁺ is a cation thereof and A⁻ is an anion thereof. The catalysts herein are preferably non-blocked and the catalysts and compositions herein are preferably free-of traditional blocking agent that commonly require high temperatures to deblock (such as mono or dicarboxylic acids, sulfonic acid and its derivatives, phosphoric acid or phosphonic acid and their organic analogs, hydrochloric acid, hydrobromic acid, phenol, and the like blocking agents).

The phrase “Michael addition,” as used herein refers to the nucleophilic addition of a carbanion or other nucleophile to an electron-deficient ethylenically unsaturated compound, such as an α,β-unsaturated carbonyl compound, for example. The abbreviated form “MA” is used interchangeably herein with the term “Michael addition.” An exemplary reaction scheme for a Michael addition reaction may be as follows:

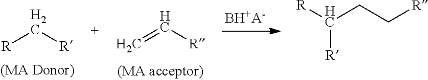

In the reaction schematic shown above, BH⁺A⁻ is a latent base catalyst as described herein that reacts with the Michael addition (MA) donor by deprotonation to form a carbanion for a subsequent addition reaction with the (MA) acceptor. In some approaches, the R and R′ groups are, independently, electron-withdrawing acyl and/or cyano groups as discussed more below.

The term “resin composition,” as used herein refers to the resin-containing portion of the composition. The resin composition may include one or more resins. Suitable examples include, without limitation, MA donors, MA acceptors, non-functional resins, and resins with functionality other than those required Michael addition.

By “Michael addition acceptor” or “MA acceptor” or “Michael acceptor” refers to a molecule or portion thereof having at least one MA acceptor functional group.

By “Michael addition donor” or “MA donor” or “Michael carbanion donor” or “Michael donor” refers to a molecule or portion thereof having at least one MA donor functional group.

By “MA acceptor/donor” is meant a molecule having at least one Michael addition (MA) acceptor functional group and at least one Michael addition (MA) donor functional group.

The term “crosslinker” refers to a molecule capable of forming a covalent linkage between polymers or between two different regions of the same polymer.

The term “self-crosslinking,” when used in the context of a self-crosslinking polymer, refers to the capacity of a polymer to enter into a crosslinking reaction with itself and/or another molecule of the polymer, in the absence of an external crosslinker, to form a covalent linkage therebetween. Typically, this crosslinking reaction occurs through reaction of complimentary reactive functional groups present on the self-crosslinking polymer itself or two separate molecules of the self-crosslinking polymer.

The term “dispersion” in the context of a dispersible polymer refers to the mixture of a dispersible polymer and a carrier. The term “dispersion” is intended to include the term “solution.”

The term “ambient temperature,” as used herein refers to the surrounding temperature in a typical indoor or room temperature environment, i.e. a temperature of about 68° F. to about 77° F. (about 20° C. to about 25° C.). Ambient temperature may also be considered “room temperature.”

The term “low-bake temperature” or “low-cure temperature” refers to a temperature of about 100° C. or less, or about 80° C. or less and, preferably about 60 to about 100° C., more preferably about, about 60 to about 80° C.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

The term “volatile organic compound” (“VOC”) refers to any compound of carbon, excluding carbon monoxide, carbon dioxide, carbonic acid, metallic carbides or carbonates, and ammonium carbonate, which participates in atmospheric photochemical reactions. Typically, volatile organic compounds have a vapor pressure equal to or greater than 0.1 mm Hg. As used herein, “volatile organic compound content” (“VOC content”) means the weight of VOC per volume of the coating solids, and is reported, for example, as kilograms (kg) of VOC per liter. VOC as reported herein is measured, for example, according to ASTM D2369-90. As used herein, waterborne systems are low VOC (e.g., about 0.5 kg/L or less), zero VOC, or may be substantially free of VOCs.

Unless otherwise indicated, the term “polymer” includes both homopolymers and copolymers (i.e., polymers of two or more different monomers).

As used herein, without the need for, without substantial levels of, in the absence of, or substantially free of, devoid of or free-of generally means (unless apparent from the context of the discussion) the coating compositions herein have less than about 1 weight percent, in other approaches, less than about 0.5 weight percent, in other approaches, less than about 0.2 weight percent, and in yet other approaches, none of the particular component or additive. In addition, (unless apparent from the context of the discussion), significantly free with respect to an ingredient means about 0.5 weight percent or less, substantially free with respect to an ingredient means about 0.2 weight percent or less, substantially completely free of an ingredient means about 0.1 weight percent or less, and completely free of an ingredient means none of such ingredient or at least no functional amount of such ingredient.

When referring to a polymer, oligomer, or copolymer, and a particular monomer or reactant is described, it is also intended that such discussion refers to the resulting monomer unit or associated repeating unit when polymerized within the polymer, oligomer, or copolymer. Likewise, when a monomer unit or repeating unit of a polymer, oligomer, or copolymer is described, the corresponding monomer or reactant is also contemplated by this disclosure. As used herein, the terms polymer or copolymer are interchangeable unless the context of discussion suggests otherwise. A polymer or copolymer herein typically have a weight average molecular weight of about 1,000 to about 40,000 and an oligomer typically has a molecular weight below 1000. Molecular weight is determined by gel permeation chromatography (GPC) using commercially available polystyrene standards. As used herein, unless the context suggests otherwise, the term “polymer” includes both homopolymers (repeating units are derived from the same monomer) and copolymers (i.e., polymers of two or more different monomers). Similarly, “oligomer” includes both homo-oligomers and co-oligomers.

As used herein, (meth)acrylate monomer(s) or monomer unit(s) include both acrylate monomer(s) and monomer unit(s) and methacrylate monomer(s) and monomer unit(s) as well as functionalized (meth)acrylate monomer(s) or monomer unit(s) suitable for incorporation into the functionalized polymers or oligomers disclosed herein. Functional moieties may also bear other crosslinking groups, photo-reactive groups, anti-fouling agents, light absorbers, anti-corrosion agents, and the like as needed for a particular application or use.

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

The present description provides a latent base catalyst for use in two-component crosslinkable coating systems, and preferably a strong latent base catalyst including carbonate, bicarbonate, and/or carbamate salts suitable for use in two-component Michael addition chemistry. This disclosure also describes crosslinkable two-composition waterborne or solvent borne coating compositions including the latent base catalysts herein. The catalysts and compositions herein can extend pot-life and improve the cure kinetics of two-component Michael addition chemistry and are suitable, for instance, during room temperature and low-bake curing conditions.

### Latent Base Catalyst

In one approach or embodiment, the latent base catalyst is a salt having a structure of BH⁺A⁻ (Formula I). The BH⁺ moiety thereof is a cation of a strong base or the conjugated acid of a strong base and includes one of a linear or cyclic amidine moiety or cation, a linear or cyclic guanidine moiety or cation, or a phosphazene moiety or cation. The A moiety thereof is a carbonate anion, a bicarbonate anion, or a carbamate anion. In approaches, the strong base catalysts of the present disclosure undergo degradation to release carbon dioxide and water or alcohol to generate neutral strong bases or ionic liquids. Such catalysts extend pot-life and promote desired cure kinetics of two-component coating systems at room temperature and low-bake (about 100° C. or less) cure conditions.

In one approach, the latent base catalysts herein include the BH⁺ moiety or cation of Formula I as an amidine-based cation and, in such form, has the structure of Formula II

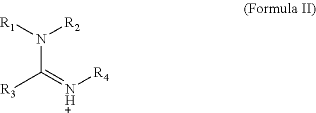

wherein R₁, R₂, R₃, and R₄ are each, independently, hydrogen or a substituted or unsubstituted alkyl group, such as a C1 to C25, C1 to C12, C1 to C6, or C₁ to C₄ substituted or unsubstituted alkyl group. In other approaches, the amidine-based cation may be a cyclic or fused bicyclic cation structure. For instance, each of R₂ and R₄ of an exemplary amidine cyclic cation of Formula II may be a substituted or unsubstituted alkyl group and R₂ and R₄, along with the atoms to which they are attached, combine to form a substituted or unsubstituted first ring structure such as where R₂ and R₄ combined provide 2 to 18 total carbons in a first ring structure. In other approaches, each of R₁ and R₃ of the amidine-based cation may also be a substituted or unsubstituted alkyl group and R₁ and R₃, along with the atoms to which they are attached, also combine to form a substituted or unsubstituted second ring structure where R₁ and R₃ combined provide 3 to 19 carbons in the second ring structure.

In other approaches, examples of amidine-based cations of Formula II may include, but are not limited, to the following amidine-based cation structures of BH⁺:

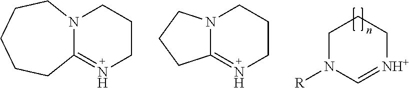

wherein R in the above structures may be hydrogen or a substituted or unsubstituted alkyl group, such as a C1 to C25, C1 to C12, C1 to C6, or C₁ to C₄ substituted or unsubstituted alkyl group and n is an integer of 1 to 18, 1 to 10, or preferably 1, 2, or 3 with 1 being most preferred.

In other embodiments, the latent base catalysts of the present disclosure include the BH⁺ cation of Formula I as a guanidine-based cation and, in such context, has the structure of Formula III

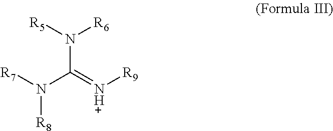

wherein R₅, R₆, R₇, R₈ and R₉ are each, independently, hydrogen or a substituted or unsubstituted alkyl group. In other approaches, the guanidine-based cation may be a cyclic or fused bicyclic structure. For instance, the guanidine-based cation may have a structure each of R₅ and R₇ are substituted or unsubstituted alkyl groups and R₅ and R₇, along with the atoms to which they are attached, combine to form a substituted or unsubstituted first ring structure and each of R₆ and R₉ are the substituted or unsubstituted alkyl group and R₆ and R₉, along with the atoms to which they are attached, combine to form a substituted or unsubstituted second ring structure. In such cyclic forms, R₅ and R₇ combined may provide 3 to 18 carbons in the first ring structure and R₆ and R₉ combined may provide 3 to 18 carbons in the second ring structure.

In other approaches, examples of guanidine cations of Formula I include, but are not limited, to the following guanidine-based cations of BH⁺:

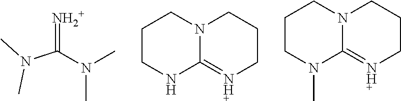

In other embodiments, the latent base catalysts of the present disclosure include the BH⁺ cation of Formula I as a phosphazene-based cation and, in such context, has the structure of Formula IV

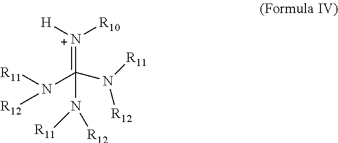

wherein R₁₀, R₁₁, and R₁₂ are each, independently, hydrogen or a substituted or unsubstituted alkyl group and, optionally, adjacent R₁₁ and R₁₂ groups on the nitrogen atom or adjacent nitrogen atoms, along with the atoms to which they are attached, may combine to form a substituted or unsubstituted ring structure. The phosphazenes can also be dimeric, tetrameric or polymeric. In some approaches, R₁₁ and R₁₂ can form a ring structure.

The latent base catalysts herein are protected strong bases. In such context, the pKa in water of the conjugated acid of the unprotected base in the latent base catalyst of at least about 10, at least about 15, at least about 18, or at least about 20.

In other approaches or embodiments, the A moiety of the catalysts herein is the anion of the latent base catalysts and, in one form, may be selected form a carbonate anion or a bicarbonate anion and, in such context, have a structure of Formula V

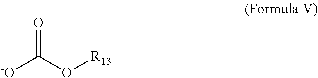

wherein R₁₃ is hydrogen, alkyl, aryl, alkaryl, hydrocarbyl, or combinations thereof. In approaches, the R₁₃ moiety is a hydrocarbyl group and wherein, optionally, one or more carbon atoms thereof is replaced with a moiety selected from —O—, —S—, —C(O)—, —C(O)O—, —OC(O)O—, —S(O)—, —SO2-, —N(Rₓ)—, —Si(—Rₓ)(R_{y})—, or combinations thereof, wherein Rₓ and R_{y} are each independently selected from hydrogen, a hydrocarbyl group, or a substituted hydrocarbyl group. In yet other approaches, the R₁₃ moiety of the anion is aromatic or heterocyclic.

Exemplary carbonate or bicarbonate anions of Formula V may include, but are not limited, to the following anion structures:

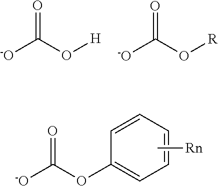

wherein R and Rn of the structure above may hydrogen, alkyl, aryl, alkaryl, hydrocarbyl, or combinations thereof. In approaches, the R or Rn of the structures above is a hydrocarbyl group and wherein, optionally, one or more carbon atoms thereof is replaced with a moiety selected from —O—, —S—, —C(O)—, —C(O)O—, —OC(O)O—, —S(O)—, —SO2-, —N(Rₓ)—, —Si(—Rₓ)(R_{y})—, or combinations thereof, wherein Rₓ and R_{y} are each independently selected from hydrogen, a hydrocarbyl group, or a substituted hydrocarbyl group

In other approaches or embodiments, the A moiety of the latent base catalyst is the anion of the catalysts herein and may be a carbamate anion and, in such context, have a structure of Formula VI

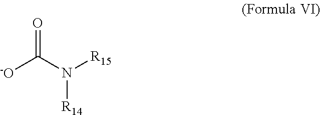

wherein R₁₄ and R₁₅ are each, independently, hydrogen or linear or branched alkyl, aryl, alkaryl, hydrocarbyl, or combinations thereof. In yet other approaches, the R₁₄ and R₁₅ of the anion are or combine to form aromatic or heterocyclic groups as noted below. In approaches, one or both of R₁₃ and R₁₄ is, independently, a hydrocarbyl group and wherein, optionally, one or more carbon atoms thereof may be replaced with a moiety selected from —O—, —S—, —C(O)—, —C(O)O—, —OC(O)O—, —S(O)—, —SO2-, —N(Rₓ)—, —Si(—Rₓ)(R_{y})—, or combinations thereof, wherein Rₓ and R_{y} are each independently selected from hydrogen, a hydrocarbyl group, or a substituted hydrocarbyl group. In yet other approaches, R₁₄ and R₁₅ including the nitrogen atom to which they are attached combine to form an aliphatic, aromatic, or heterocyclic ring structure. The carbamate ring structure, in approaches or embodiments, may be a heterocyclic ring structure, such as but not limited to a succinimide ring structure.

Exemplary carbamate anions of Formula VI may include, but are not limited to, the following anion structures:

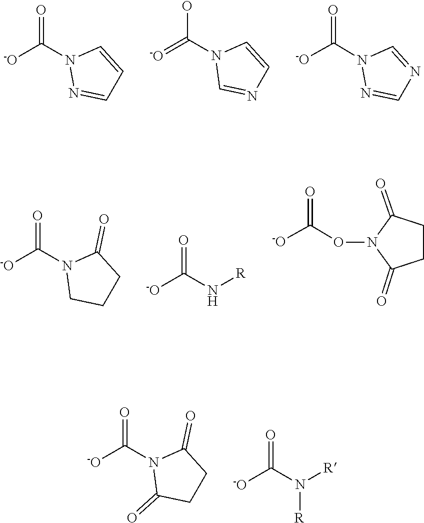

wherein R and R′ in the above structures may be, independently, hydrogen or a substituted or unsubstituted alkyl group, such as a C1 to C25, C1 to C12, C1 to C6, or C₁ to C₄ substituted or unsubstituted alkyl group.

The latent base catalysts herein are strong base substituted carbonate or carbamate salts that, preferably, undergo degradation to regenerate a strong neutral base or protic ionic liquid or a mixture of a strong base and an ionic liquid as catalysts, that is dependent on the pKas of the unprotected base and the amines, alcohols or phenols upon which the carbamates or carbonates are based. Based on the strength of the bases and acids, the salts may display different activation temperature as well as catalytic efficiency, which are related to pot life and cure kinetics.

In one approach, the latent strong bases as catalysts herein undergo degradation to release for example, carbon dioxide and water to generate neutral strong bases. For example, the following scheme illustrates the activation mechanism of a representative strong base bicarbonate catalyst to regenerate a free strong base by releasing carbon dioxide and water:

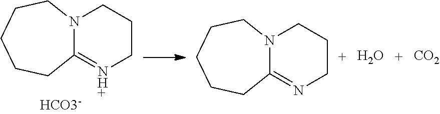

In another approach, the latent strong bases undergo decomposition to release carbon dioxide and alcohols to generate neutral strong bases. For instance, the following scheme demonstrates the degradation mechanism of a representative strong base carbonate catalyst to produce a neutral strong base by releasing carbon dioxide and ethanol:

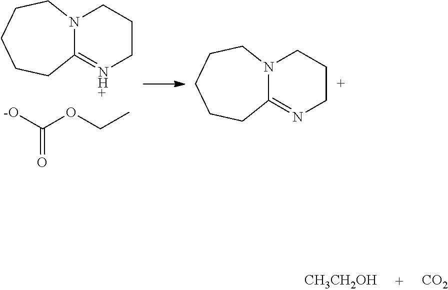

In another approach, the latent strong bases can undergo degradation to release carbon dioxide to generate ionic liquids. The following scheme illustrates the activation mode of a representative latent base for which the pKa of the conjugated acid of the strong base is more than the pKa of the neutral amine:

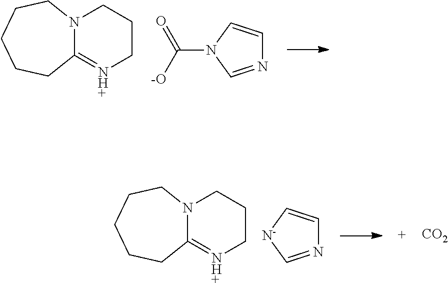

In one approach or embodiment, the latent bases are fairly stable in their pure forms or solution states at room temperature and can be activated after application as the generated carbon dioxide leaves the surface so the equilibrium shifts to the right and more and more neutral bases or ionic liquids are generated to catalyze the reaction. The cure temperature may be about 5° C. to about 100° C., preferably about 10° C. to about 80° C., and more preferably about 15° C. to about 60° C. Depending on the difference between the conjugated acid of the strong base and the free alcohols, amines or phenols, not only is the anionic portion after the decomposition suitable as a strong base catalyst, the neutral form from the cation may also function as a strong base catalyst.

### Coating Composition

In another embodiment or approach of this disclosure, a coating composition including a water-based or an organic solvent-based carrier fluid, a strong latent base catalyst as described hereinabove, and a resin system having a Michael addition coating system. In approaches, the composition includes at least one ingredient or portion thereof having at least two protons that can be activated to form a Michael carbanion donor or MA donor, i.e. a molecule having at least one MA donor functional group, and a second ingredient or portion thereof having at least two ethylenically unsaturated functionalities each active by an electron-withdrawing group to form a Michael acceptor at least one MA acceptor, i.e. a molecule having at least one MA donor functional group. In one approach, malonate and acetoacetate-based systems may be used as the MA donors and acrylate-based systems may be used as the MA acceptor. Other polymers may be polyester acrylate systems, polyurethane systems, acrylic dispersion, and epoxy systems as needed for a particular application.

Suitable examples of MA donors include, but are not limited to, dialkyl malonates (e.g., dimethyl malonate, diethyl malonate, and the like), cyanoacetates (e.g., methyl cyanoacetate, ethyl cyanoacetate, and the like), chloroacetates, acetoacetates, propionyl acetates, malononitrile, acetonitrile, acetylacetone, dipropionyl methane, and the like, and mixtures or combinations thereof. Preferred examples of MA donors include, but are not limited to, malonate or acetoacetate group containing oligomeric and polymeric compounds such as, for example, polyesters, polyurethanes, polyacrylates, epoxy resins, polyamides, and polyvinyl resins containing malonate or acetoacetate functional groups in the main chain, pendant, or both.

In an embodiment, the MA donor described herein is at least one polymeric resin having Michael addition donor functional groups. In an aspect, the backbone of the MA donor includes a polyester backbone, a polyurethane backbone, a polyacrylate backbone, an epoxy backbone, or a polyamide backbone. In a preferred aspect, the backbone of the MA donors may be aliphatic or aromatic. Suitable aromatic epoxy resins that can be functionalized to act as MA donors include, but are not limited to, MA functionalized bisphenol A epoxy and novolac epoxy resins. In an aspect, the epoxy resins can be functionalized by reaction with diketene, transesterification with an alkyl acetoacetate or dialkyl malonate, esterification of the epoxy resin with malonic acid or a monoester or acid functional malonated polyester, and the like.

Suitable examples of MA acceptors include, but are not limited to, esters of (meth)acrylic acid, i.e. a (meth)acrylate functional compound derived from the reaction of an hydroxyl functional compound (i) with (meth)acrylic acid or its ester derivatives (ii), wherein the hydroxyl functional compound can be mono-, di-, or polyfunctional and has as a backbone that contains an aliphatic, cycloaliphatic or aromatic chain, a (poly)epoxy, (poly)ether, (poly)ester for example (poly)caprolactone, (poly)alkyd, (poly)urethane, (poly)amine, (poly)amide, (poly)carbonate, (poly)olefin, (poly)siloxane, (poly)acrylate, halogen (e.g. fluorine), a melamine-derivative, copolymers of any of them, and the like, and mixtures and combinations thereof.

Preferred examples of such MA acceptors include, without limitation, the multifunctional acrylate derivatives of glycidyl epoxy resins (e.g., diglycidyl ether of bisphenol A) and phenolic novolac epoxy resins. Exemplary MA acceptors may include an aromatic epoxy acrylate. In an aspect, the MA acceptor is multifunctional, i.e. the MA acceptor has a functionality of preferably 2 or more. Suitable examples of MA acceptors with aromatic epoxy backbone include, without limitation, acrylated glycidyl epoxy resins (e.g., diglycidyl ether of bisphenol A (BPA)), and acrylated novolac epoxy resins. In one aspect, the MA acceptor described herein is a difunctional BPA epoxy acrylate.

Without limiting to theory, it is believed that a multifunctional MA donor and a multifunctional MA acceptor will react via a Michael addition reaction as described above, and thereby help improve cure speed, crosslink density, and hardness development for the coating compositions described herein. The improved cured and increased crosslink density will lead to improved performance characteristics.

In an embodiment, the MA donor and the MA acceptor are mixed together to obtain a coating composition. In an aspect, the MA donor and MA acceptor will each independently be present in an amount of about 5 to about 50 percent by weight, preferably about 10 to about 40 percent by weight, based on the total weight of the coating composition. In an aspect, stoichiometric index of MA donor acidic protons to MA acceptor unsaturated groups is about 10:1 to about 0.1:1, preferably about 5:1 to about 0.2:1, more preferably about 1.5:1 to about 0.7:1 or in other approaches, about 1:3 to about 3:1, about 1:2 to about 2:1, or about 1:1.5 to about 1.5:1.

In an embodiment, the amount of latent base catalyst used herein may vary depending on the properties of the coating composition. In one approach, the composition includes about 0.001 to 1 meq catalyst per gram of resin solids, more preferably 0.02 to 0.07 meq per gram of resin solids. In other approaches, the compositions herein may include about 0.01 weight percent to about 20 weight percent of the latent base catalysts, preferably about 0.1 weight percent to about 10 weight percent, more preferably about 0.5 weight percent to about 5 weight percent of the latent base catalysts herein.

Optionally, to extend open-time and potlife, one or more additional components may be included, such as, for example, one or more acidic X′—H groups, where X′ is N, P, O, S, or C, where the X′ anion is a MA donor capable of reaction with the MA acceptor, and the pKa of the X′—H group is lower than the pKa of the majority MA donor (e.g. acetoacetate-functional resin), preferably more than 2 units lower. Suitable examples include, without limitation, ethyl-acetoacetate, benzotriazole, succinimide, acetyl acetone, or 1,2,4-triazolem, and mixtures or combinations thereof. In one aspect, the open time extender may be benzotriazole, and if present in the compositions herein, in an amount of about 0.5 to about 5 weight percent or, more preferably, about 0.5% to about 1.5%, based on the total weight of resin solids.

In another embodiment, the coating compositions described herein may optionally include an acid-scavenging or pH-buffering component. Suitable examples include, without limitation, metal oxide (e.g., zinc oxide, nanoparticular zinc oxide, magnesium oxide, calcium oxide, strontium oxide, barium oxide, lanthanum oxide, ytterbium oxide, zirconium oxide, and the like), mixed metal oxide (e.g., MgO—TiO2, and the like), zeolites (e.g., cesium-exchanged zeolite, X, Y—Cs-occluded zeolite, and the like), modified mesoporous materials (e.g., MgO-coated mesoporous silica (SBA-15), amino-functionalized mesoporous silica (MCM-41), mesoporous silicon oxynitride, and the like), metal hydroxide (e.g., calcium hydroxide, Na/NaOH/Al₂O₃, Na/MgO, and the like), metal nitride, metal oxynitride (e.g., silicon, oxynitride, aluminophosphate oxynitride, zirconophosphate oxynitride, calcined NaNO3, and the like), metal carbonate (e.g., calcium carbonate, sodium carbonate, potassium carbonate, and the like), metal silicate (e.g., calcium silicate, calcium borosilicate, magnesium silicate, Mg—Al hydrotalcite, chrysotile, and the like), metal carboxylate salts (e.g., titanium acetylacetate, and the like), organic metal compounds (e.g., organic zirconate, weak base titanate, tetraalkyl titanate, and the like), amines (e.g., guanidine, aziridine, amidine, triethanolamine, DMP30, and the like), imides (e.g., carbodiimide, and the like), diaza-bicyclo compounds (e.g., DABCO, and the like), and mixtures or combinations thereof.

Accordingly, in an embodiment, the coating compositions described herein are applied over an acidic substrate, such as for example, a metal substrate with a pretreatment applied thereon. Suitable examples of pretreatment include, without limitation, iron phosphate, zinc phosphate, silane, zirconium, and the like. Many other pretreatments are known in the metal pretreatment industry. In one aspect, the metal substrates herein may have an iron phosphate treatment applied thereon.

In some embodiments, the coating compositions described herein optionally include one or more adhesion promoters. By “adhesion promoter” is meant an additive that is included in a coating composition to form primary bonds with either the substrate surface or with any previously applied coating or pretreatment. As used herein, the one or more adhesion promoters function to improve dry adhesion, wet adhesion, or preferably, both, of a primer composition to the substrate. Suitable examples of adhesion promoters useful with the coating compositions described herein include, without limitation, silanes, silicones, catalytic metals, and the like. Of these, organosilane adhesion promoters or coupling agents are preferred. In an embodiment, if present in the coating composition, the adhesion promoter is present in an amount of about 2 to about 20 weight percent, more preferably about 5 to about 15 weight percent, and even more preferably about 7 to about 10 percent by weight, based on the total weight of resin solids in the coating composition.

The coating composition described herein may also include other optional ingredients that do not adversely affect the coating composition or a cured coating composition resulting therefrom. Such optional ingredients are typically included in a coating composition to enhance coating aesthetics; to facilitate manufacturing, processing, handling, and application of the composition; and to further improve a particular functional property of a coating composition or a cured coating composition resulting therefrom. For example, the composition described herein may optionally include fillers, catalysts, lubricants, pigments, surfactants, dyes, colorants, toners, coalescents, extenders, anticorrosion agents, flow control agents, thixotropic agents, dispersing agents, antioxidants, adhesion promoters, light stabilizers, and mixtures thereof, as required to provide the desired film properties. Each optional ingredient is preferably included in a sufficient amount to serve its intended purpose, but not in such an amount to adversely affect a coating composition or a cured coating composition resulting therefrom.

In an embodiment, the composition described herein may include resin components that do not undergo Michael addition reaction, in addition to the MA donors and MA acceptors described herein. These additional resin components may have no reactive functional groups or have reactive functional groups that undergo reactions other than the Michael addition reaction. In some approaches, the resins may have other cure chemistries, such as urethane, epoxy, alkyd, thermal cure chemistry and the like so long as such systems do not materially interfere with the Michael addition reactions described herein.

For example, in an aspect, the composition described herein may include a co-reactant, such as, without limitation, an amine co-reactant. The presence of such a co-reactant helps improve certain performance characteristics of the composition described herein, such as corrosion resistance. In an aspect, where the composition described herein is a two-part composition, the co-reactant may be included in the first part (part A) or in the second part (part B) of the composition. In a preferred aspect, the co-reactant is an amine co-reactant present in part B of the composition. If present, the amine co-reactant is present in an amount of about 0.01 to about 1 weight percent, in other approaches about 0.05 to about 0.1 weight percent, based on the total weight of the resin solids.

In an embodiment, the coating composition described herein may include a solvent. Suitable solvents may be aqueous, organic, or mixtures thereof. Suitable examples of organic solvents include, without limitation, aliphatic solvents, aromatic and/or alkylated aromatic solvents (e.g., toluene, xylene, and the like), alcohols (e.g., isopropanol), esters (e.g., methoxy propanol acetate, butyl acetate, isobutyl acetate, and the like), ketones (e.g., methyl ethyl ketone, methyl amyl ketone, and the like), glycol ethers, glycyl ether esters, and mixtures or combinations thereof. In an aspect, the coating composition described herein has a low volatile organic compound (VOC) content, preferably less than 400 g/L, more preferably less than 300 g/L, and most preferably less than 250 g/L, and more preferably less than about 200 g/L. The coating compositions herein may have about 10 to about 30 weight percent of the solvent, in other approaches, about 15 to about 25 weight percent of the solvent, and in yet other approaches, about 18 to about 22 weight percent of the solvent. The solvent or carrier fluids herein may be about 5 to about 100 weight percent water.

In an embodiment, the coating composition described herein may be used as a primer or may be part of a primer formulation. When used as a primer or in a primer formulation, the composition described herein may be applied over an untreated substrate, a pretreated substrate, a substrate with a temporary coating applied thereon, and the like. In a preferred aspect, the composition described herein is applied over a metal substrate with an acidic pretreatment, preferably a phosphate pretreatment. In some approaches, Michael addition chemistry is not necessarily suitable for acidic surfaces and in such context, a primer system (PUD, epoxy, and the like) may be applied upon the acidic surface first to form a surface suitable for the Michael addition chemistries herein.

In an embodiment, the coating composition described herein may be used as a topcoat. In an aspect, a first coating (such as a primer, for example) is applied over an untreated substrate, a pretreated substrate, a substrate with a temporary coating applied thereon, and the like. Then, a second coating (such as a topcoat, for example) is applied over the primer. In an aspect, the second coating is applied only after the first coating has fully dried or cured. In an alternative aspect, the second coating is applied over the first coating before the first coating has fully dried or cured. Where the coating composition is intended for exterior usage and/or intended to be a weatherable coating, for example as a topcoat or direct-to-metal (monocoat) application, it is preferred that the resin backbone of all MA acceptors and MA donors within the composition includes less than 100%, preferably less than 75%, and more preferably less than 50% of an epoxy backbone.

In an embodiment, the coating composition described herein may be used as a primer, and any topcoat may be applied over the described primer. In an aspect, the topcoat composition is also obtained by a Michael addition reaction. The Michael addition-derived topcoat may be the same or different than the Michael addition-derived primer composition described herein. In another aspect, the topcoat composition may be a component not derived by a Michael addition reaction, but known in the art as a suitable topcoat material, such as a polyurethane topcoat, for example. Michael addition-derived topcoats are known in the art, as described in U.S. Pat. No. 8,962,725, for example, incorporated herein by reference. In other approaches, any primer used herein generally is not Michael addition-derived but rather from other chemistries like epoxy, urethane, and the like.

The compositions described herein also show improved shelf life and potlife. In an aspect, the compositions described herein have optimal shelf-life and demonstrate no loss of cure-response or any viscosity increase after storage for up to one week or more at temperatures for water based Michael addition systems. For solvent based Michael addition system, the pot-life can be several hours to a couple of days. In another aspect, the coating compositions described herein also demonstrate optimal potlife, where the composition takes preferably longer than 60 minutes, more preferably longer than 120 minutes, to double in viscosity after mixing.

The coating composition of the present invention may be applied to a substrate either prior to, or after, the substrate is formed into an article. In an aspect, the coating composition described herein may be applied on a variety of substrates. Suitable examples include, without limitation, natural and engineered buildings and building materials, freight containers, flooring materials, walls, furniture, other building materials, motor vehicles, motor vehicle components, aircraft components, trucks, rail cars and engines, bridges, water towers, cell phone tower, wind towers, radio towers, lighting fixtures, statues, billboard supports, fences, guard rails, tunnels, pipes, marine components, machinery components, laminates, equipment components, appliances, and packaging. Exemplary substrate materials include, without limitation, wood, plastics, thermosets, metals, metal alloys, intermetallic compositions, metal-containing composites, and combinations of these. Exemplary metal substrates include, without limitation, aluminum, steel, weathering steel, and stainless steel. In a preferred aspect, the substrate is steel, preferably steel with a pretreatment applied thereon.

The coating composition described herein may be applied by any method known in the art. Standard methods of application include, without limitation, such as by brushing, spraying, spin coating, roll coating, curtain coating, dipping, gravure coating, bell application, and/or the like. In the case of two-component thermoset substrates, the coating may be applied via in-mold processes. When the coating composition is applied by spray methods, both conventional air or air-assisted spray equipment, or airless spray equipment may be used. Both electrostatic and non-electrostatic equipment may be used.

The coating thickness of a particular layer and the overall coating system will vary depending upon the coating material used, the substrate, the coating application method, and the end use for the coated article. When used as a primer applied over an untreated or pretreated metal substrate, the thickness of the applied coating film is preferably about 0.05 to about 20 mils (about 1.27 to about 500 microns), more preferably about 0.4 to about 40 mil (about 10 to about 100 micron), and even more preferably about 1.0 to about 2.5 mils (about 25 to about 70 microns).

In an embodiment, the composition described herein provides a cured coating with optimal cure and corrosion resistance. In an aspect, after the coating is applied to a substrate, it is cured within 1 to 10 minutes at a bake temperature of 100° C. or less, where the term “cured” means at least partially, preferably fully, cross-linked. As a measure of optimal cure, the cured coating demonstrates, in one approach, a pencil hardness of preferably least H, more preferably at least 2H, even more preferably at least 5H (as measured pursuant to ASTM D3363). In another approach, a 6 mil wet drawdown of a coating composition including the catalysts herein applied on a cold rolled steel substrate, when cured at room temperature of about 25° C., achieves a Konig Hardness of about 10 to about 150 after at least 7 days. Hardness can be determined using pencil hardness or pendulum hardness to judge the cure extent of coating and measured pursuant to ASTM D4366. In further approaches, a coating composition herein when a 6 mil wet drawdown is applied to a cold rolled steel substrate, when cured at 60° C. for about 45 minutes, achieves a Konig Hardness of about 40 to about 150 after at least 7 days.

### EXAMPLES

The following examples are illustrative of exemplary embodiments of the disclosure. In these examples, as well as elsewhere in this application, all ratios, parts, and percentages are by weight unless otherwise indicated. It is intended that these examples are being presented for the purpose of illustration only and are not intended to limit the scope of the invention disclosed herein.

### Part A—Catalyst Examples

### Example 1

An example of a latent strong base catalyst having an amidinium structure in the form of 1,8-diazabicyclo[5.4.0]undec-7-ene bicarbonate is prepared as follows: In an aerosol can without the capillary dipping tube, 80.00 g of 1,8-diazabicyclo[5.4.0]undec-7-ene and 9.47 g of water and 150 mL of ethyl acetate were added. The can was sealed, and carbon dioxide was charged to the pressure of 180 psi (1241 kPa). The can was let sit over the weekend at ambient or room temperature before the pressure was released. The can was cut open and the product was collected by filtration and dried in air overnight. Yield: 112.6 g, quantitative. Nuclear Magnetic Resonance (NMR) showed that the product has a structure consistent with 2,3,4,6,7,8,9,10-octahydropyrimido[1,2-a]azepin-1-ium hydrogen carbonate.

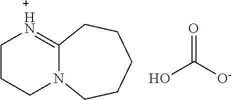

### Example 2

The procedure of example 1 was followed except that 1,5-Diazabicyclo(4.3.0) non-5-ene was used in place of 1,8-diazabicyclo[5.4.0]undec-7-ene to generate the product in a form of white powder. The NMR Nuclear Magnetic Resonance (NMR) showed that the product has a structure consistent with 2,3,4,6,7,8-hexahydropyrrolo[1,2-a]pyrimidin-1-ium hydrogen carbonate.

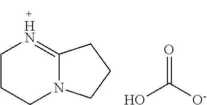

### Example 3

The procedure of example 1 was followed except that 1,1,3,3-tetramethylguanidine was used in place of 1,8-diazabicyclo[5.4.0]undec-7-ene to generate the product in a form of white powder. NMR showed that the product has a structure consistent with bis(dimethylamino)methaniminium hydrogen carbonate.

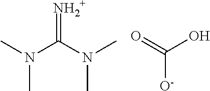

### Example 4

In an aerosol can without the capillary dipping tube, 10.00 g of 1,8-diazabicyclo[5.4.0]undec-7-ene and 18.95 g of ethanol were added. The can was sealed and filled with carbon dioxide at the pressure of 180 psi (1241 kPa). The can was let to stand still at ambient conditions overnight before the pressure was released. The carbon dioxide uptake is about 3.14 g. The can was cut open and the resulted solution was used directly without purification (50 wt % in ethanol). NMR showed that the product has a structure consistent with 2,3,4,6,7,8,9,10-octahydropyrimido[1,2-a]azepin-1-ium ethyl carbonate

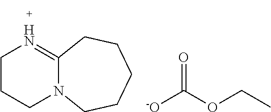

### Example 5

In a 100 mL jar, 10.00 g of 1,8-diazabicyclo[5.4.0]undec-7-ene and 1.45 g of water were added and 50 mL of ethyl acetate. The solution was bubbled with carbon dioxide under agitation. The precipitates were collected by filtration to give the final product in a form of white solid. NMR showed that the product has a structure consistent with 3,4,6,7,8,9-hexahydro-2H-pyrimido[1,2-a]pyrimidin-1-ium hydrogen carbonate.

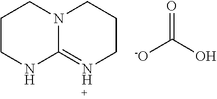

### Example 6

Step 1: In a 100 mL jar, 10 g of 1,8-diazabicyclo[5.4.0]undec-7-ene and 4.47 g of imidazole were added. The mixture was heated to 60° C. and stirred overnight. The resulting liquid was used directly for the next step.

Step 2: In an aerosol can without the capillary dipping tube, 10 g of 2,3,4,6,7,8,9,10-octahydropyrimido[1,2-a]azepin-1-ium imidazol-1-ide was added. The can was sealed and filled with carbon dioxide at the pressure of 180 psi (1241 kPa). The can was let to stand for 48 hours before the pressure was released. The carbon dioxide uptake was 2.35 g. The can was cut open and the product was collected. Yield was 10.9 g in the form of a brown viscous liquid. NMR showed that the product has a structure consistent with 2,3,4,6,7,8,9,10-octahydropyrimido[1,2-aJazepin-1-ium 1H-imidazole-1-carboxylate.

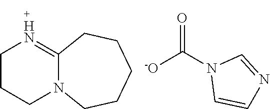

### Example 7

The procedure of example 6 was followed except that pyrazole was used in place of imidazole in step 1 and 2,3,4,6,7,8,9,10-octahydropyrimido[1,2-a]azepin-1-ium pyrazol-1-ide was used in place of 2,3,4,6,7,8,9,10-octahydropyrimido[1,2-a]azepin-1-ium imidazol-1-ide in step 2. Yield was about 10.2 g in the form of a brown viscous liquid. NMR showed that the product has a structure consistent with 2,3,4,6,7,8,9,10-octahydropyrimido[1,2-a]azepin-1-ium 1H-pyrazole-1-carboxylate.

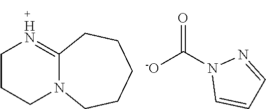

### Example 8

The procedure of example 6 was followed except that 1,2,4-triazole was used in place of imidazole in step 1 and 13.65 g of 2,3,4,6,7,8,9,10-octahydropyrimido[1,2-a]azepin-1-ium 1,2,4-triazol-1-ide in place of 10.00 g of 2,3,4,6,7,8,9,10-octahydropyrimido[1,2-a]azepin-1-ium imidazol-1-ide in step 2. Yield was about 16.0 g in the form of a slightly brown viscous liquid. NMR showed that the product has a structure consistent with 2,3,4,6,7,8,9,10-octahydropyrimido[1,2-a]azepin-1-ium 1H-1,2,4-triazole-1-carboxylate.

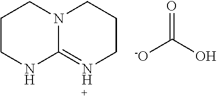

### Example 9

The procedure of example 6 was followed except that 1,5-Diazabicyclo(4.3.0) non-5-ene was used in place of 1,8-diazabicyclo[5.4.0]undec-7-ene and 1,2,4-triazole was used in place of imidazole in step 1 and 2,3,4,6,7,8-hexahydropyrrolo[1,2-a]pyrimidin-1-ium 1,2,4-triazol-1-ide in place of 2,3,4,6,7,8,9,10-octahydropyrimido[1,2-a]azepin-1-ium imidazol-1-ide in step 2. Yield was about 9.5 g in the form of a brown viscous liquid. NMR showed that the product has a structure consistent with 2,3,4,6,7,8-hexahydropyrrolo[1,2-a]pyrimidin-1-ium 1H-1,2,4-triazole-1-carboxylate.

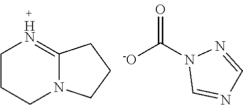

### Example 10

The procedure of example 6 was followed except that 1,1,3,3-tetramethylguanidine was used in place of 1,8-diazabicyclo[5.4.0]undec-7-ene and 2-pyrrolidone was used in place of imidazole in step 1 and bis(dimethylamino)methaniminium 2-oxopyrrolidin-1-ide in place of 2,3,4,6,7,8,9,10-octahydropyrimido[1,2-a]azepin-1-ium imidazol-1-ide in step 2. Yield was about 11.2 g in the form of light brown solids. NMR showed that the product has a structure consistent with bis(dimethylamino)methaniminium 2-oxopyrrolidine-1-carboxylate.

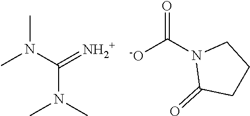

### Example 11

The procedure of example 6 was followed except that 1,1,3,3-tetramethylguanidine was used in place of 1,8-diazabicyclo[5.4.0]undec-7-ene in step 1 and bis(dimethylamino) methaniminium imidazol-1-ide in place of 2,3,4,6,7,8,9,10-octahydropyrimido[1,2-a]azepin-1-ium imidazol-1-ide in step 2. Yield was about 11.0 g in the form of a brown liquid. NMR showed that the product has a structure consistent with bis(dimethylamino)methaniminium 1H-imidazole-1-carboxylate.

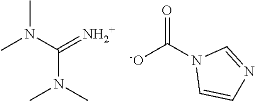

### Example 12

The procedure of example 6 was followed except that 1,1,3,3-tetramethylguanidine was used in place of 1,8-diazabicyclo[5.4.0]undec-7-ene and pyrazole was used in place of imidazole in step 1 and bis(dimethylamino)methaniminium pyrazol-1-ide in place of 2,3,4,6,7,8,9,10-octahydropyrimido[1,2-a]azepin-1-ium imidazol-1-ide in step 2. Yield was about 11.2 g in the form of a brown liquid. NMR showed that the product has a structure consistent with bis(dimethylamino)methaniminium 1H-pyrazole-1-carboxylate.

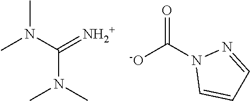

### Example 13

The procedure of example 6 was followed except that 2-pyrrolidone was used in place of imidazole in step 1 and 2,3,4,6,7,8,9,10-octahydropyrimido[1,2-a]azepin-1-ium 2-oxopyrrolidin-1-ide was used in place of 2,3,4,6,7,8,9,10-octahydropyrimido[1,2-a]azepin-1-ium imidazol-1-ide in step 2. Yield was about 8.5 g in the form of a brown viscous liquid. NMR showed that the product has a structure consistent with 2,3,4,6,7,8,9,10-octahydropyrimido[1,2-aJazepin-1-ium 2-oxopyrrolidine-1-carboxylate.

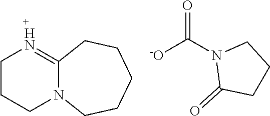

### Example 14

The procedure of example 6 was followed except that 1,5-Diazabicyclo(4.3.0) non-5-ene was used in place of 1,8-diazabicyclo[5.4.0]undec-7-ene and 2-pyrrolidone was used in place of imidazole in step 1 and 2,3,4,6,7,8-hexahydropyrrolo[1,2-a]pyrimidin-1-ium 2-oxopyrrolidin-1-ide in place of 2,3,4,6,7,8,9,10-octahydropyrimido[1,2-a]azepin-1-ium imidazol-1-ide in step 2. Yield was about 8.9 g in the form of a brown viscous liquid. NMR showed that the product has a structure consistent with 2,3,4,6,7,8-hexahydropyrrolo[1,2-a]pyrimidin-1-ium 2-oxopyrrolidine-1-carboxylate.

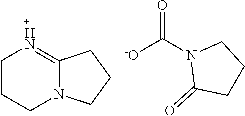

### Example 15

The procedure of example 6 was followed except that 1,5-Diazabicyclo(4.3.0) non-5-ene was used in place of 1,8-diazabicyclo[5.4.0]undec-7-ene in step 1 and 2,3,4,6,7,8-hexahydropyrrolo[1,2-a]pyrimidin-1-ium imidazol-1-ide in place of 2,3,4,6,7,8,9,10-octahydropyrimido[1,2-a]azepin-1-ium imidazol-1-ide in step 2. Yield was about 12.15 g in the form of a brown solid. NMR showed that the product has a structure consistent with 2,3,4,6,7,8-hexahydropyrrolo[1,2-a]pyrimidin-1-ium 1H-imidazole-1-carboxylate.

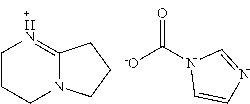

### Example 16

The procedure of example 6 was followed except that 1,5-Diazabicyclo(4.3.0) non-5-ene was used in place of 1,8-diazabicyclo[5.4.0]undec-7-ene and pyrazole was used in place of imidazole in step 1 and 2,3,4,6,7,8-hexahydropyrrolo[1,2-a]pyrimidin-1-ium pyrazol-1-ide in place of 2,3,4,6,7,8,9,10-octahydropyrimido[1,2-a]azepin-1-ium imidazol-1-ide in step 2. Yield was about 10.9 g in the form of a light brown semisolid. NMR showed that the product has a structure consistent with 2,3,4,6,7,8-hexahydropyrrolo[1,2-a]pyrimidin-1-ium 1H-pyrazole-1-carboxylate.

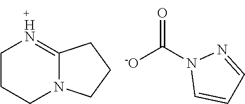

### Example 17

The procedure of example 6 was followed except that 1,1,3,3-tetramethylguanidine was used in place of 1,8-diazabicyclo[5.4.0]undec-7-ene and succinimide was used in place of imidazole in step 1 and bis(dimethylamino)methaniminium 2,5-dioxopyrrolidin-1-ide in place of 2,3,4,6,7,8,9,10-octahydropyrimido[1,2-a]azepin-1-ium imidazol-1-ide in step 2. Yield was about 8.73 g in the form of a light brown viscous liquid. NMR showed that the product has a structure consistent with bis(dimethylamino)methaniminium 2,5-dioxopyrrolidine-1-carboxylate.

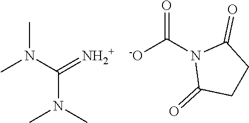

### Example 18

The procedure of example 4 was followed except that 4.8 g of n-butyl amine was used in place of 18.95 g of ethanol. The product was collected with scraping. Yield was about 16.8 g in the form of viscous light yellow viscuous liquid. NMR showed that the product has a structure consistent with 2,3,4,6,7,8,9,10-octahydropyrimido[1,2-a]azepin-1-ium butylcarbamate.

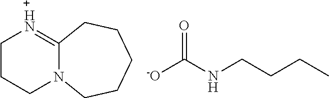

### Example 19

The procedure of example 6 was followed except that phenol was used in place of imidazole in step 1 and 2,3,4,6,7,8,9,10-octahydropyrimido[1,2-a]azepin-1-ium phenolate was used in place of 2,3,4,6,7,8,9,10-octahydropyrimido[1,2-a]azepin-1-ium imidazol-1-ide in step 2. Yield was about 8.1 g in the form of a brown viscous liquid. NMR showed that the product has a structure consistent with 2,3,4,6,7,8,9,10-octahydropyrimido[1,2-a]azepin-1-ium phenyl carbonate.

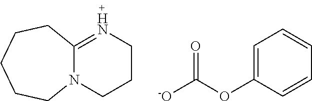

### Example 20

The procedure of example 4 was followed except that 1,5-Diazabicyclo(4.3.0) non-5-ene was used in place of 1,8-diazabicyclo[5.4.0]undec-7-ene and 20.79 g of ethanol was used instead of 18.95 g. Yield was about 34.5 g in the form of a clear liquid (50 wt %). NMR showed that the product has a structure consistent with 2,3,4,6,7,8-hexahydropyrrolo[1,2-a]pyrimidin-1-ium ethyl carbonate.

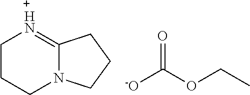

### Example 21

The procedure of example 4 was followed except that 15 g 1,8-diazabicyclo [5.4.0]undec-7-ene and 31.18 g of propanol were used in place of 10 g of 1,8-diazabicyclo [5.4.0]undec-7-ene and 18.95 g of ethanol. Yield was about 56.4 g in the form of a light-yellow liquid (50 wt %). NMR showed that the product has a structure consistent with 2,3,4,6,7,8,9,10-octahydropyrimido[1,2-a]azepin-1-ium propyl carbonate.

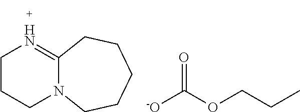

### Example 22

The procedure of example 4 was followed except that 15 g 1,8-diazabicyclo [5.4.0]undec-7-ene and 33.94 g of propanol were used in place of 10 g of 1,8-diazabicyclo [5.4.0]undec-7-ene and 18.95 g of ethanol. Yield was about 53 g in the form of a light-yellow liquid (50 wt %). NMR showed that the product has a structure consistent with 2,3,4,6,7,8,9,10-octahydropyrimido[1,2-a]azepin-1-ium butyl carbonate.

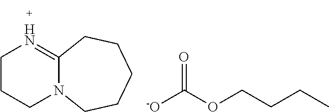

### Example 23

The procedure of example 4 was followed except that 15 g 1,8-diazabicyclo [5.4.0]undec-7-ene and 39.86 g of 2-propoxyethanol were used in place of 10 g of 1,8-diazabicyclo[5.4.0]undec-7-ene and 18.95 g of ethanol. Yield was about 59 g in the form of a light-yellow liquid (50 wt %). NMR showed that the product has a structure consistent with 2,3,4,6,7,8,9,10-octahydropyrimido[1,2-a]azepin-1-ium 2-propoxyethyl carbonate.

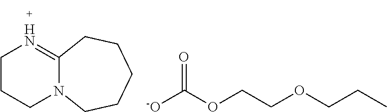

### Example 24

The procedure of example 4 was followed except that 20 g 1,8-diazabicyclo [5.4.0]undec-7-ene and 7.89 g of 2-propanol were used in place of 10 g of 1,8-diazabicyclo [5.4.0]undec-7-ene and 18.95 g of ethanol. Yield was about 28.62 g in the form of pale-yellow solids. NMR showed that the product has a structure consistent with 2,3,4,6,7,8,9,10-octahydropyrimido[1,2-a]azepin-1-ium isopropyl carbonate.

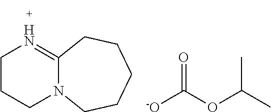

### Example 25

The procedure of example 4 was followed except that 25 g 1,8-diazabicyclo [5.4.0]undec-7-ene and 8.78 g of 2-dimethylaminoethanol were used in place of 10 g of 1,8-diazabicyclo[5.4.0]undec-7-ene and 18.95 g of ethanol. Yield was about 4.7 g in the form of a viscous gel. NMR showed that the product has a structure consistent with 2,3,4,6,7,8,9,10-octahydropyrimido[1,2-a]azepin-1-ium 2-(dimethylamino)ethyl carbonate.

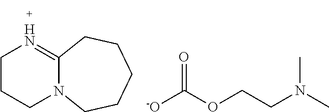

### Example 26

The procedure of example 4 was followed except that 4 g phosphazene base P1-t-Bu-tris(tetramethylene) and 0.23 g of water were used in place of 10 g of 1,8-diazabicyclo [5.4.0]undec-7-ene and 18.95 g of ethanol. Yield: 4.7 g in the form of a viscous gel. NMR showed that the product has a structure consistent with 2-methyl-N-(tri (pyrrolidin-1-yl)-25-phosphaneylidene) propan-2-aminium hydrogen carbonate.

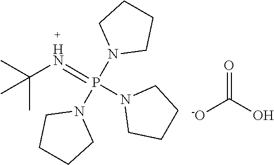

### Part B—Resin Examples

For waterborne applications, Acure AQ 620-100 from Allnex was used, which was a malonate & acrylate functional non-ionic polyurethane dispersion resin with an optimized ratio of Michael Donor and Acceptor groups as one of the main binders to evaluate the catalysts. Commercial waterborne acrylate dispersions that are developed for waterborne UV coatings and normally have high acid numbers can be used as Michael acceptor resins. Nonionic/low acid Michael donor or acceptor containing dispersions can be prepared separately to demonstrate the efficacy and application scope of the catalysts. In some cases, solvent based Michael addition resins can be used for waterborne applications if they can be emulsified.

For solvent-based applications, solvent based Acure resins from Allnex can be used. Examples of Michael Donor resins are Acure™ 510-100, 102, 170, 172, 174, 190, 200, 270, 300, 302, 370, 372, 375, and 400. Michael Acceptor resins are Acure™ 550-100, 105, 200, and 405. Acrylate monomers or oligomers from other UV resin companies like IGM, Sartomer, Dymax, BASF, Miwon, Rahn etc. can be used as Michael acceptor resins as well.

### Part C—Coating Examples

### Evaluation of the Efficacy of Catalysts in a Commercial Resin at Room Temperature:

The DBU bicarbonate catalyst of Example 1 was incorporated at 2 weight percent into Acure™ AQ 620-100 from Allnex according to the formula in Table 1. All other catalysts were used equivalently to 2 weight percent DBU bicarbonate based on their molecular weight. The dispersion was mixed, and 6 mil wet drawdowns were applied on cold rolled steel substrates. The coatings were dried at room temperature (25° C.) evaluated for Konig pendulum hardness (ASTM D4366) at different times. Results are provided in Table 2 below.

TABLE 1
Model formula to evaluate catalysts

| Component | Amount |
|---|---|
| Acure AQ 620-100 | 30.0 g |
| DBU bicarbonate | 0.6 g in 2.0 g of water |

TABLE 2
Coating Konig pendulum hardness after drying at room
temperature and pot-life

| catalyst | Hardness @ day 1 | Hardness @ day 7 | pot-life |
|---|---|---|---|
| Example 1 | 40 | 98 | >7 d |
| Example 2 | 40 | 66 | >7 d |
| Example 3 | 17 | 56 | >7 d |
| Example 4 | 70 | 114 | >7 d |
| Example 5 | 12 | 40 | <1 d |
| Example 6 | 51 | 100 | >1 d; < 7 d |
| Example 7 | 49 | 100 | >7 d |
| Example 8 | 64 | 93 | <1 d |
| Example 9 | 31 | 69 | <1 d |
| Example 10 | 17 | 47 | <1 d |
| Example 11 | 25 | 54 | >1 d |
| Example 12 | 19 | 49 | >1 d |
| Example 13 | 53 | 104 | >1 d |
| Example 14 | 41 | 83 | >1d |
| Example 15 | 40 | 90 | <1 d |
| Example 16 | 48 | 90 | >1 d |
| Example 17 | 12 | 24 | <1 d |
| Example 18 | 45 | 99 | <1 d |
| Example 19 | 41 | 86 | <1 d |
| Example 20 | 15 | 76 | >7 d |
| Example 21 | 19 | 96 | >7 d |
| Example 22 | 17 | 47 | >7 d |
| Example 23 | 10 | 24 | >7 d |
| Example 24 | 65 | 125 | >1 d |
| Example 25 | 33 | 87 | >1 d |
| Example 26 | 46 | 66 | >7 d |
| DBU | 5 | 31 | <1 d |
| DBN | 41 | 84 | <1 d |
| TMG | 11 | 27 | <1 d |
| TBD | 2 | 3 | <1 d |
| Phosphazene | 33 | 38 | instant grits |
| base P1 | | | |
| blank | Sticky; no cure | Sticky; no cure | n/a |

The pot-life was evaluated for coatings prepared at day 1 and 7 with the same dispersion and the resulting coatings were cured at room temperature. If the day 7 hardness is over 80% of that of the original coating, the pot-life is good.
DBU: 1,8-Diazabicyclo (5.4.0) undec-7-ene; DBN: 1,8-Diazabicyclo 5.4.0 undec-7-ene; TMG: 1,1,3,3-Tetramethylguanidine; TBD: 1,5,7-Triazabicyclo [4.4.0] dec-5-ene; Phosphazene base P1: Phosphazene base P1-t-Bu-tris (tetramethylene)

The results summarized in Table 2 demonstrated that the blocked bases can cure the water-based Michael addition resins at room temperature and provide higher efficacy or longer pot-life or both compared with their parent bases.

### Evaluation of Exemplary Blocked Catalysts at Low-Bake Condition

The two formulas listed in Table 3 were used to demonstrate the benefits of the invented catalysts that can cure the coatings at low-bake conditions. DBU is the parent compound of example 1 and equal moles are used for comparison. The applied coatings were cured at the following conditions: cured room temperature for seven days; flash at room temperature for 1 hr and baked at 80° C. and cured at room temperature for the rest of time; flash at room temperature for 1 hr followed by baked at 80° C. for 24 hours and then cured at room temperature for the rest of time. The results are list in Table 4.

TABLE 3
Formulas to demonstrate low-bake cure

| Acure 620-100 | 30.00 g | 30.0 g |
|---|---|---|
| Example 1 | 0.6 g in 2.0 g of water | |
| DBU | | 0.43 g in 2.0 g of water |

The results in Table 4 show that the coatings with example 1 can be cured at low bake conditions at different stages with a faster speed. For comparison, the coatings with the parent compound DBU did not demonstrate benefits except the case of curing at 80° C. for 24 hours.

TABLE 4
Cured at room temperature for 7 days

| | Hardness | Hardness | Hardness | Hardness |
|---|---|---|---|---|
| | @ day 1 | @ day 2 | @ day 5 | @ day 7 |
| Example 1 | 40 | 58 | 81 | 98 |
| DBU | 3 | 8 | 21 | 35 |

Flash at room temperature for 1 hr, baked at 80 ºC. for 1 hr and
cured at room temperature for the rest of the time

| | Hardness | Hardness | Hardness | Hardness |
|---|---|---|---|---|
| | @ day 1 | @ day 2 | @ day 5 | @ day 7 |
| Example 1 | 83 | 86 | 95 | 101 |
| DBU | 9 | 13 | 13 | 22 |

Cured at room temperature for 1 day, baked at 80 ºC. for 1 hr and
cured at room temperature for the rest of the time

| | Hardness | Hardness | Hardness | Hardness |
|---|---|---|---|---|
| | @ day 1 | @ day 2 | @ day 5 | @ day 7 |
| Example 1 | 36 | 89 | 97 | 107 |
| DBU | 2 | 12 | 16 | 22 |

flash at room temperature for 1 hr, baked at 80 ºC. for 24 hr and
cured at room temperature for the rest of the time

| | Hardness | Hardness | Hardness | Hardness |
|---|---|---|---|---|
| | @ day 1 | @ day 2 | @ day 5 | @ day 7 |
| Example 1 | 98 | 104 | 105 | 111 |
| DBU | 82 | 84 | 84 | 94 |

Evaluation of Exemplary Blocked Catalysts with Solvent Based Michael Addition Resins

Table 5 summarizes a two-part solvent borne Michael addition formulation with exemplary blocked catalysts and controls. Part A was prepared by mixing the Michael donor resin (Acure 510-170), Michael accepter resin (Acure™ 550-105) and methylethylketone (MEK). Part B is the catalyst in ethanol. The ratio of the acrylate to the active His 0.98. The catalyst was used at 3 mol % of the amount of acrylate. The part B was added to part A under stirring (150-200 rpm) for 2 min and the resulting formulas were applied right away. The pot-life was checked by recording the gel-time. The gel time is the length of time that the formula stops flowing in a vial.

TABLE 5
Solvent borne Michael addition formula with
exemplary catalysts

| | A | B | C | D | E | F | G |
|---|---|---|---|---|---|---|---|
| Part A | | | | | | | |
| Acure | 25.00 g | 25.00 g | 25.00 g | 25.00 g | 25.00 g | 25.00 g | |
| 510- | | | | | | | |
| 170 | | | | | | | |
| Acure | | | | | | | 25.20 |
| 510- | | | | | | | g |
| 100 | | | | | | | |
| Acure | 13.94 g | 13.94 g | 13.94 g | 13.94 g | 13.94 g | 13.94 g | 13.94 |
| 550- | | | | | | | g |
| 105 | | | | | | | |
| methyl- | 18.00 g | 18.00 g | 18.00 g | 18.00 g | 18.00 g | 18.00 g | 18.00 |
| ethyl- | | | | | | | g |
| ketone | | | | | | | |
| Part B | | | | | | | |
| Exam- | 0.77 g | | | | | | 0.77 g |
| ple1 | | | | | | | |
| Exam- | | 0.67 g | | | | | |
| ple2 | | | | | | | |
| Exam- | | | 2.64 g | | | | |
| ple4 | | | | | | | |
| DBU | | | | 0.55 g | | | |
| DBN | | | | | 0.45 g | | |
| Blank | | | | | | | |
| ethanol | 2.00 g | 2.00 g | 0.23 g | 2.00 g | 2.00 g | 2.00 g | 2.00 g |

Acure ™ 510-170 is a malonate functional polyester resin with succinimide from Allnex
Acure ™ 510-100 is a malonate functional polyester resin without succinimide from Allnex
Acure ™ 550-105 is an acid-free tetra-functional polyester acrylate from Allnex

The results summarized in Table 6 demonstrate that the inventive blocked catalysts show faster kinetics and longer gel-time compared to the unprotected parent bases.

TABLE 6

| | Hardness @ day 1 | Hardness @ day 7 | Gel time |
|---|---|---|---|
| A | 31 | 48 | 24 hr |
| B | 32 | 33 | 4 hr |
| C | 49 | 66 | 24 hr |
| D | 29 | 41 | 3 hr |
| E | 11 | 17 | 5-10 min |
| F | No cure | No cure | n/a |
| G | 13 | 37 | Between 8-24 hr |

A number of formulations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

It is noted that, as used in this specification and the appended claims, the singular forms a,” “an,” and “the,” include plural referents unless expressly and unequivocally limited to one referent. Thus, for example, reference to “an antioxidant” includes two or more different antioxidants. As used herein, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is to be understood that each component, compound, substituent or parameter disclosed herein is to be interpreted as being disclosed for use alone or in combination with one or more of each and every other component, compound, substituent or parameter disclosed herein.

It is further understood that each range disclosed herein is to be interpreted as a disclosure of each specific value within the disclosed range that has the same number of significant digits. Thus, for example, a range from 1 to 4 is to be interpreted as an express disclosure of the values 1, 2, 3 and 4 as well as any range of such values.

It is further understood that each lower limit of each range disclosed herein is to be interpreted as disclosed in combination with each upper limit of each range and each specific value within each range disclosed herein for the same component, compounds, substituent or parameter. Thus, this disclosure to be interpreted as a disclosure of all ranges derived by combining each lower limit of each range with each upper limit of each range or with each specific value within each range, or by combining each upper limit of each range with each specific value within each range. That is, it is also further understood that any range between the endpoint values within the broad range is also discussed herein. Thus, a range from 1 to 4 also means a range from 1 to 3, 1 to 2, 2 to 4, 2 to 3, and so forth.

Furthermore, specific amounts/values of a component, compound, substituent or parameter disclosed in the description or an example is to be interpreted as a disclosure of either a lower or an upper limit of a range and thus can be combined with any other lower or upper limit of a range or specific amount/value for the same component, compound, substituent or parameter disclosed elsewhere in the application to form a range for that component, compound, substituent or parameter.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

1. A latent base catalyst for use in two-component crosslinkable coating systems, the latent base catalyst comprising:
a salt having a structure of BH⁺A⁻ (Formula I);
wherein BH⁺ is a conjugated acid of a strong base and includes a linear or cyclic amidine moiety, a linear or cyclic guanidine moiety, or a phosphazene moiety; and
wherein A⁻ is a carbonate anion, a bicarbonate anion, or a carbamate anion.

2. The latent base catalyst of claim 1, wherein BH⁺ of Formula I includes the amidine moiety and has the structure of Formula II 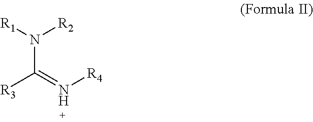
wherein R₁, R₂, R₃, and R₄ are each, independently, hydrogen or a substituted or unsubstituted alkyl group.

3. The latent base catalyst of claim 2, wherein each of R₂ and R₄ are the substituted or unsubstituted alkyl group and R₂ and R₄, along with the atoms to which they are attached, combine to form a substituted or unsubstituted first ring structure.

4. The latent base catalyst of claim 3, wherein R₂ and R₄ combined provide 2 to 18 carbons in the first ring structure

5. The latent base catalyst of claim 3, wherein each of R₁ and R₃ are the substituted or unsubstituted alkyl group and R₁ and R₃, along with the atoms to which they are attached, combine to form a substituted or unsubstituted second ring structure.

6. The latent base catalyst of claim 5, wherein R₁ and R₃ combined provide 3 to 19 carbons in the second ring structure.

7. The latent base catalyst of claim 1, wherein BH⁺ of Formula I includes the guanidine moiety and has the structure of Formula III 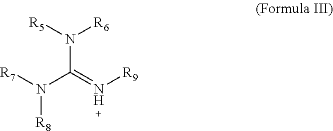
wherein R₅, R₆, R₇, R₈ and R₉ are each, independently, hydrogen or a substituted or unsubstituted alkyl group.

8. The latent base catalyst of claim 7, wherein each of R₅ and R₇ are the substituted or unsubstituted alkyl group and R₅ and R₇, along with the atoms to which they are attached, combine to form a substituted or unsubstituted first ring structure and each of R₆ and R₉ are the substituted or unsubstituted alkyl group and R₆ and R₉, along with the atoms to which they are attached, combine to form a substituted or unsubstituted second ring structure.

9. The latent base catalyst of claim 8, wherein of R₅ and R₇ combined provide 3 to 18 carbons in the first ring structure and R₆ and R₉ combined provide 3 to 18 carbons in the second ring structure.

10. The latent base catalyst of claim 1, wherein BH⁺ of Formula I includes the phosphazene moiety and has the structure of Formula IV 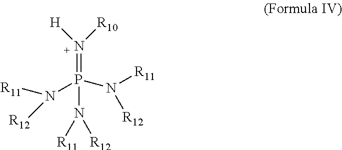
wherein R₁₀, R₁₁, and R₁₂ are each, independently, hydrogen or a substituted or unsubstituted alkyl group and, optionally, adjacent R₁₁ and R₁₂ groups, along with the atoms to which they are attached, may combine to form a substituted or unsubstituted ring structure

11. The latent base catalyst of claim 1, wherein A⁻ has the structure of Formula V 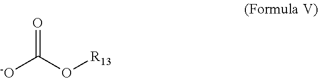
wherein R₁₃ is hydrogen, alkyl, aryl, alkaryl, hydrocarbyl, or combinations thereof.

12. The latent base catalyst of claim 11, wherein R₁₃ is a hydrocarbyl group and wherein, optionally, one or more carbon atoms thereof is replaced with a moiety selected from —O—, —S—, —C(O)—, —C(O)O—, —OC(O)O—, —S(O)—, —SO2-, —N(Rₓ)—, —Si(—Rₓ)(R_{y})—, or combinations thereof, wherein Rₓ and R_{y} are each independently selected from hydrogen, a hydrocarbyl group, or a substituted hydrocarbyl group.

13. The latent base catalyst of claim 1, wherein A⁻ has the structure of Formula VI 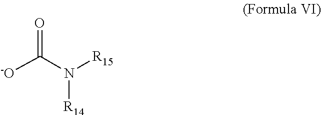
wherein R₁₄ and R₁₅ are each, independently, hydrogen or linear or branched alkyl, aryl, alkaryl, hydrocarbyl, or combinations thereof.

14. The latent base catalyst of claim 13, wherein one or both of R₁₃ and R₁₄ is, independently, a hydrocarbyl group and wherein, optionally, one or more carbon atoms thereof is replaced with a moiety selected from —O—, —S—, —C(O)—, —C(O)O—, —OC(O)O—, —S(O)—, —SO2-, —N(Rₓ)—, —Si(—Rₓ)(R_{y})—, or combinations thereof, wherein Rₓ and R_{y} are each independently selected from hydrogen, a hydrocarbyl group, or a substituted hydrocarbyl group.

15. The latent base catalyst of claim 13, wherein R₁₄ and R₁₅ including the nitrogen atom to which they are attached combine to form a heterocyclic succinimide ring structure.

16. The latent base catalyst of claim 15, wherein the pKa in water of the conjugated acid of the base in the latent base catalyst is at least about 10.

17. (canceled)

18. (canceled)

19. A crosslinkable two-component waterborne or solvent borne coating composition comprising:
a water-based or an organic solvent-based carrier fluid comprising 5 to 100 weight percent water, based on the total weight of the carrier fluid;
a first ingredient or portion thereof having at least two protons that can be activated to form a Michael carbanion donor;
a second ingredient or portion thereof having at least two ethylenically unsaturated functionalities each activated by an electron-withdrawing group to form a Michael acceptor; and
about 0.01 to about 20 weight percent of the latent base catalyst of claim 1, and wherein the composition includes a weight ratio of the Michael carbanion donor to the Michael acceptor of about 1:3 to about 3:1, preferably about 1:2 to about 2:1, and more preferably about 1:1.5 to about 1.5:1.

20. The crosslinkable two-component waterborne or solvent borne coating composition of claim 19, wherein the coating composition further includes pigments, matting agents, fillers, wetting agents, defoamers, rheological modifiers, ultraviolet (UV) light stabilizers, dispersing agents, flow and leveling agents, optical brighteners, gloss additives, radical inhibitors, radical initiators, adhesion promotors, plasticizers, waxes, or combinations thereof.

21. (canceled)

22. (canceled)

23. (canceled)
